(19) United States
(12) Patent Application Publication
(10) Pub. No.: US 2025/0211418 A1
(43) Pub. Date: Jun. 26, 2025

(54) DATA PROCESSING METHOD

(71) Applicant: COMMISSARIAT A L'ENERGIE ATOMIQUE ET AUX ENERGIES ALTERNATIVES, Paris (FR)

(72) Inventors: Aymen BOUDGUIGA, Gif-sur-Yvette Cedex (FR); Renaud SIRDEY, Gif-sur-Yvette Cedex (FR); Oana STAN, Gif-sur-Yvette Cedex (FR); Martin ZUBER, Gif-sur-Yvette Cedex (FR); Marc RENARD, Gif-sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 18/990,641

(22) Filed: Dec. 20, 2024

(30) Foreign Application Priority Data
Dec. 21, 2023 (FR) FR2314913

(51) Int. Cl. H04L 9/00; H04L 9/14; H04L 9/40

(52) U.S. Cl. CPC H04L 9/008; H04L 9/14; H04L 63/0435

(57) ABSTRACT

Data processing method for obtaining a result with a combination of elementary operations; wherein
two encryptions [Enc1,Dec1; Enc2,Dec2] are defined, one indecipherable by a server, the other indecipherable by a TEE; and
S1) an emitting client supplies and encrypts an input data item;
S2) it sends it under encryption to the server or to the TEE;
S3) via data processing, these two computers apply the combination of elementary operations to the encrypted data item received so as to obtain a ciphertext of the result, that they send to a receiving client;
S4) the latter deciphers the ciphertext of the result and obtains the result.

During step S3, the server only processes processed data under encryption indecipherable by the server, and the TEE only processes processed data under encryption indecipherable by the TEE.

### TECHNICAL FIELD OF THE INVENTION

The field of the invention is the field of data processing and particularly, secure data processing.

More specifically, the invention relates to a method for processing data in a system comprising two computers to obtain a result securely based on input data supplied by clients or users of the system.

### PRIOR ART

The present disclosure is part of a substantial trend in recent years in terms of data processing, which is the increasing use of the ‘cloud’, i.e. cloud architectures, to carry out various processing operations on data regardless of their type.

However, the transfer of these operations to the cloud in turn naturally raises new issues, in particular the difficulty ensuring data confidentiality and the integrity of the operations carried out.

Various encryption techniques have been developed to address the need for data confidentiality.

Among these, homomorphic encryption techniques are particularly distinguished. Advantageously, homomorphic encryption allows processing operations applied to data be carried out on encrypted data. Nevertheless, homomorphic encryption uses ciphertexts of a very large size compared to that of the initial data. This results in a substantial increase in the quantity of computing operations to be carried out, which is naturally extremely problematic for the implementation of this technique.

Furthermore, although these techniques prove to be effective for preventing data breaches in respect of third parties, they can exhibit a limited effectiveness against certain types of players, particularly privileged players: system administrator, cloud infrastructure supplier, or more generally any person authorised to act upon processing operations.

To remedy these drawbacks, it has been proposed (see for example document Ref.2 or 4) to delegate at least a portion of the data processing carried out on homomorphic ciphertexts (such computing operations will be referred to hereinafter as ‘carried out in homomorphic mode’) in a Trusted Execution Environment, or “TEE”, type secure secondary computer. Such a computer type is defined in particular by document Ref.4.

Such computing delegation advantageously significantly reduces the quantity of computing operations to be carried out.

However, these methods which combine homomorphic encryption and the delegation of certain data processing operations with a TEE remain limited to very specific applications, for example, secure key exchange, training of a neural network with homomorphic encryption for quadratic functions and the remainder of the computing in the TEE, an aggregation method combining homomorphic computing and delegation of computing to a TEE, etc.

Furthermore, all these solutions are situated in the context of a TEE which can hypothetically be presumed to be trusted. For this reasons, these methods do not provide protective measures against an “honest-but-curious” TEE. As a reminder, in the field of cryptographic and security protocols, an “honest-but-curious” computer (also known as a passive or semi-honest adversary) is a type of adversary that follows the protocol correctly, but tries to learn as much as possible using the information available (see document Ref.4).

Finally, these solutions do not necessarily ensure computing security if the server adopts a malicious behaviour.

### DISCLOSURE OF THE INVENTION

The aim of the present invention is that of proposing a data processing method making it possible to prevent the risks suggested above.

To this end, a data processing method is proposed wherein computing operations are carried out in a distributed manner on two computers, namely a server and a security hardware module, or TEE, the method making it possible to ensure data confidentiality including if the server adopts a malicious behaviour, whereas the TEE adopts an “honest-but-curious” behaviour.

To this end, according to the present disclosure, a method is proposed for processing data in a system comprising two computers to obtain a result using at least one input data item to be supplied by at least one emitting client, the result being computable by applying a combination of elementary operations to at least one input data item; wherein one of the computers is a server, and the other is a trusted execution environment, TEE; a first encryption and a second encryption are defined, one being indecipherable by the server, and the other being indecipherable by the TEE; the method includes the following steps:
S1) at least one emitting client supplies a first input data item and applies the first encryption to it;
S2) said at least one emitting client sends the input data item under the first encryption to one of the computers;
S3) during a data processing operation, the two computers apply the combination of elementary operations to said encrypted data item received in step S2 so as to obtain a ciphertext of the result, and send this result to at least one receiving client, step S3 including the following elementary steps:
   S31) the first computer encrypts the processed data item under second encryption;
   S32) the first computer sends the second computer the processed data item obtained, encrypted under first and second encryption; and
   S33) the second computer removes the first encryption from the processed data item received;
S4) said at least one receiving client deciphers the ciphertext of the result and obtains the result;
during the data processing performed in step S3, the server only processes processed data under at least the encryption indecipherable by the server, and the TEE only processes processed data under at least the encryption indecipherable by the TEE, which may be in particular be masking encryption; and
the first and the second encryption verify the property, for any processed data item x:

Dec2(Dec1(Enc2(Enc1(x))))=Dec2(Enc2(x)).

In the present document, the expression ‘data under encryption’ denotes a data item which is encrypted at least using the encryption in question. The data item can optionally be under double (or triple) encryption.

The encryption being indecipherable by the server means for example that the server does not have the deciphering function, or does not have the deciphering key.

The server only processing processed data under at least the encryption indecipherable by the server means that any processed data item sent to the server is previously encrypted under at least the encryption indecipherable by the server. Similarly, the TEE only processing processed data under at least the encryption indecipherable by the TEE means that any processed data item sent to the TEE is previously encrypted under at least the encryption indecipherable by the TEE.

In certain implementations, one of the encryptions is decipherable by the server and not by the TEE, and the other of the two encryptions conversely is decipherable by the TEE but not by the server.

The TEE is a component which generally has a relatively small memory capacity. Preferably, the memory of the TEE has a capacity not exceeding 1 GB, or preferably not exceeding 512 MB (Megabytes), or more preferably not exceeding 256 MB. Naturally, it is assumed that the TEE is honest as to the processing operations it applies to the processed data.

In the method, the first computer can be the server and the second computer the TEE, or vice versa.

The central step of the method defined above is step S3. During this step, a processing operation is applied by the computers to the encrypted input data item received in step S2.

This processing includes a certain number of elementary operations.

These elementary operations successively convert the initial input data item into different processed data. The term ‘processed data item’ denotes a data item obtained using the initial data item during processing. When all the elementary operations making up the processing have been carried out, the computers obtain a ciphertext of the result. This is then sent to one or more clients (referred to as receiving clients).

Thus during the processing, the computers apply the combination of elementary operations to the received data item, which allows them to obtain the ciphertext of the desired result.

Importantly in the method, in step S3, instead of being executed on plaintext data x, all the operations carried out during the processing are executed on encrypted data [x].

Each of the computers is therefore configured to apply each of the relevant processing operations not on a plaintext data item, but on a corresponding encrypted data item. Thus, in particular, if an elementary operation consists of applying a function f to a processed data item x, according to the method, one of the computers actually applies a function \tilde{ƒ} to the encrypted data item [x] so as to supply as an output an encrypted result equal to the ciphertext of the result, or [f(x)]. The computer therefore actually applies a function \tilde{ƒ} to the ciphertext [x] of the data item x, and supplies as an output the ciphertext of the result: \tilde{ƒ}([x])=[ƒ(x)]. To simplify hereinafter, the function \tilde{ƒ} is annotated f like the function from which it is derived.

In the method generally, in a manner known per se, the operations making up the processing are executed exclusively on integers modulo a predefined maximum value T.

In the method, advantageously the data are encrypted during all of the steps (or operations) performed, whether they are performed by the server or by the TEE. Hence, this method makes it possible to carry out these steps securely, not only if the server is malicious, but also if the TEE adopts an “honest-but-curious” behaviour.

In the method, according to the implementation and unless specified otherwise, any application and any removal of an encryption to or from a data item can optionally be preceded or followed by an elementary operation modifying the processed data item.

In the present document a masking encryption includes any logical addition making it possible to modify the data item which is encrypted (using the mask), for example an addition, a logical ‘exclusive OR’ (XOR) function, etc.

In the method, any type of encryption indecipherable by the server can be used. The encryption indecipherable by the server can be thus be or can thus comprise a homomorphic, in particular fully homomorphic, encryption.

Preferably, each operation on a processed data item carried out by the server is carried out under homomorphic encryption. In this case, the server only processes data under at least one homomorphic encryption.

Thus in certain implementations, the first encryption is a homomorphic encryption and the second encryption a masking encryption, or vice versa.

To allow the computers to carry out the processing on encrypted data, the method includes support operations during which support functions are applied to the input data, the processed data or the results, each being optionally encrypted.

‘Support function’ means here a function other than said elementary operations and which:
contributes to the execution of homomorphic computing operations by the server or to the verification thereof;
serves to encrypt or decipher data to be processed received from the client, processed data (by the computers), or results sent to the client; and/or
serves to prepare data (verification data) serving to verify data to be processed received from the client, processed data, and/or results sent to the client.

It is understood that the support functions do not take part in carrying out elementary operations (because they are other than elementary operations), but serve only either to make it possible to carry out these elementary operations on encrypted data, or to encrypt or decipher data supplied to the computers or sent thereby, or to verify or ensure that the different operations included in the method, in particular the elementary operations, have been carried out properly.

In certain implementations, in step S3, the TEE applies to the processed data item or to the processed data only one or more support functions. The elementary operations of the processing are then for their part exclusively carried out by the server.

In certain implementations, the method includes the following steps:
S0235) the second computer applies the first encryption to the deciphered data item during step S33, and sends the data item obtained to the first computer; and
S0236) the first computer removes the second encryption from the processed data item received following step S0235.

Thus, using the processed data item under second encryption available in the server in step S33, the server can supply a processed data item under double encryption to the first computer. It can remove the second encryption. If the data item processed at this stage is actually the ciphertext of the result, the first computer can then send this ciphertext of the result (under first encryption) to the client which deciphers it.

Preferably, step S0235 is performed immediately following step S33, such that during step S0235, the second computer applies the first encryption to the processed data item obtained as an output of step S33. Thanks to this, when the first encryption is a homomorphic encryption, steps S33 and S0235 make it possible to carry out a reset of the noise or a relinearisation.

As the two steps S33 and S0235 are executed immediately one after the other, with no immediate operation, they constitute a deciphering/re-encryption operation. These two grouped operations, more generally, can also constitute a bootstrapping, an LHE (‘Levelled Homomorphic Encryption’) re-linearisation, or both at the same time, or any other ciphertext management operation. They can thus be operations conducted to obtain once again a ciphertext having a “fresh ciphertext” format.

The latter operation is performed normally in the case where removing then reapplying encryption makes it possible to lower the noise level in the ciphertexts, which is the case in particular for certain homomorphic encryptions (first encryptions). This operation is performed preferably if the second computer is a TEE.

In this case, thanks to the successive deciphering and re-encryption operations performed by the TEE, when there is a transencryption operation with a high expansion factor, the size of the ciphertexts sent from and to the client can be drastically reduced which results in a reduction in bandwidth consumption between the client and the server.

Furthermore, as ciphertext maintenance operations are thus delegated to the TEE, which carries them out in a much less costly manner than the server, the homomorphic computing performance of the server is considerably increased. Re-encryption makes it possible to refresh the homomorphic ciphertexts and has an equivalent effect to a bootstrapping operation but with a better resulting noise level.

In certain implementations, the method is implemented iteratively during a plurality of computing loops. One of the encryptions can moreover be a mask encryption. In this case, for the application of mask encryption during the method, the client or the computer concerned generates a mask stream; and in each computing loop, a new mask is generated and used for masking.

In numerous implementations, the encrypted result returned to the receiving client(s) following step S3 is encrypted under at least the first encryption, but this is not necessarily the case.

Thus, unlike in certain implementations of the method, during step S3, the processed data item is encrypted under an encryption other than the first encryption or is encrypted with the first encryption but with another encryption key; and the encrypted result returned following step S3 is encrypted with a different encryption from the first encryption or is encrypted with the first encryption but with another encryption key.

These implementations therefore make it possible to carry out a key switching operation securely.

According to the implementations, the receiving client(s) receiving the encrypted result following step S3, can be identical to or different from the or each of said at least one emitting client supplying the data item in step S1.

In certain embodiments, the method furthermore includes a step S0411 preceding step S2 and during which the first client applies an additional encryption, particularly symmetric, to the data item; and after the data item has been sent to the first computer in step S2, the first computer removes the additional encryption.

This additional encryption allows the transmission of the encrypted initial data item from the client to the first computer. The second encryption can thus be applied by the first computer, and not by the client. This reduces on one hand the computing operations performed by the client (applying the additional encryption, for example symmetric, can be more straightforward than applying the second encryption, typically homomorphic). Furthermore, this does not require the client to have the encryption key of the second encryption, and reduces communication costs.

In certain implementations of the method, during an operation S0533, the TEE removes the first encryption, referred to as initial first encryption, which can in particular be a masking encryption, of the processed data item; and
during an operation S0535, the TEE applies to the processed data item a homomorphic encryption, as final first encryption;
during an operation S0535a, following step S0535, the processed data item under final first encryption and under second encryption is sent to the server;
   when all of the elementary operations have been performed, the ciphertext of the result is sent to the client under final first encryption; and in step S4, the client removes the final first encryption.

In this implementation, the client applies an initial first encryption to the data item which it sends to the first computer. During steps S0533 and S0535, the initial first encryption will be removed, then replaced by the final first encryption. Therefore, the latter will be deciphered by the client in the final step S4. This implementation therefore makes it possible to carry out a transencryption, and in particular, optionally, replace a masking encryption by a homomorphic encryption.

In this implementation, the TEE is preferably the first computer.

In step S2, the input data item under initial first encryption is first sent to the server.

After receiving this data item, during a step S0531, the server applies to the processed data item the second encryption, which is a masking encryption and sends it to the TEE, encrypted under this second encryption.

After following step S0535a, the processed data item under final first encryption and under second encryption has been sent to the server, during a step S0536, the server removes the second encryption (masking encryption). All or part of the elementary operations can be performed by the server only after carrying out step S0536.

In certain implementations of the method, the first encryption applied in step S1 is homomorphic encryption, referred to as first homomorphic encryption; during a step S0633, the TEE removes the first homomorphic encryption from the processed data item;
during a step S0635 performed after step S0633, the TEE applies to the data item a second homomorphic encryption other than the first homomorphic encryption; and in step S4, the client removes the second homomorphic encryption from the encrypted result.

This implementation makes it possible to carry out a transencryption, the first homomorphic encryption being replaced by the second homomorphic encryption by the TEE during steps S33 and S35.

### Iterative Method

In certain implementations of the method, the combination of elementary operations includes N elementary operations of order j, j=1 . . . N; step S3 includes the execution of a plurality of computing loops, iteratively; in each loop of index j, j=1 . . . N, steps S1, S31, S32 and S33, a step S0730, a step S0735 and a step S0736 are carried out as follows:
during step S1, the client supplies an input data item of index j, and sends said input data item of index j to the first computer, which is the server, as an input data item for step S0730;
during step S0730, the server applies the elementary operation of index j to the data item supplied as an input;
the server carries out step S31 of applying the second encryption to the processed data item and step S32 of sending the encrypted processed data item to the TEE; the TEE carries out step S33 of removing the first encryption from the processed data item, then in step S0735 applies once again the first encryption to the data item, then resends the thus re-encrypted data item to the server;
on receipt of said thus re-encrypted data item, the server during a step S0736a removes the second encryption therefrom; the data item thus modified is then supplied as an input data item of operation S0730 of the following computing loop where applicable.

Moreover, the security of the processing carried out by the computers can be increased when a verifiable computing protocol is known for the processing to be carried out.

The case where a verifiable computing protocol is defined, and makes it possible to verify the result by carrying out an elementary verification for each of said elementary operations is considered more particularly.

Let us take the case where the first computer is the server, and the second computer is the TEE. A tag computing function is defined in the context of the verifiable computing protocol, this function being commutative with the elementary operations gj (for the composition of functions o).

The first computer is the server, and the second computer is the TEE.

A tag computing function is defined in the context of the verifiable computing protocol, this function being commutative with the elementary operations.

The method then includes the following steps:
in step S1, the client furthermore sends the server a tag of the ciphertext under first encryption of the data item;
the second encryption is a mask encryption;
in each loop of index j, j=1 . . . N
in a step S0701a, the client supplies the server with a mask (mⱼ) and a mask tag of the mask;
during a step S0730, the server applies the elementary operation of index j to the processed data tag supplied as an input;
during a step S0731, the server encrypts the processed data item under second encryption;
during a step S0732, the server sends the TEE the processed data item obtained, encrypted under first and second encryption;
during a step S0730a, the server applies the elementary operation (g;) of index j to the data tag supplied as an input;
during a step S0731a, the server computes the tag of the ciphertext under double encryption using the tag obtained in step S0730a and the tag of the mask, and sends this tag to the TEE;
during a step S0732a, according to the encrypted data item received in step S0732, and the encrypted data tag received in step S0731a, the TEE verifies the elementary operation carried out in step S0730 by performing the elementary verification corresponding to this operation;
if the result is positive and the loop index j verifies j<N, in step S0733:
   the TEE removes the first encryption (Dec_{HE}1) from the encrypted data item received in step S0732 performed during the loop, then
   during a step S0735, applies the first encryption to the data item under second encryption and sends the encrypted data item obtained to the server;
   during a step S0736, the server removes the second encryption from the data item received following step S0735, and supplies the thus deciphered data item as an input data item for operation S0730 of the following computing loop;
   during a step S0735a, the TEE computes a tag of the encrypted data item computed in step S0735 and sends this tag to the server; then
   during a step S0736a, the server computes the tag of the unmasked ciphertext (i.e. the ciphertext from which the mask, corresponding to the second encryption, has been removed) using the tag received following step S0735a and the tag of the mask, and supplies the tag of the unmasked ciphertext as an input data item for operation S0730a of the following computing loop.

Thanks to a signature, verification and, optionally, homomorphic re-encryption operation in the TEE, a schema is constructed which establishes step by step that all the ciphertexts handled are either generated by the TEE (which, as owner of the secret homomorphic key is not an attacker on the homomorphic schema), or generated by applying legitimate homomorphic operators to ciphertexts generated by the TEE. Therefore, there is no possible CCA adversary for homomorphic encryption, which gives a stronger security level.

A signature is here any value attached to a message and which makes it possible to prove the integrity thereof: Using the message, the signature makes it possible to verify that it has not been altered. A signature is generally obtained in cryptography using a hash of the message, for example using a known public-key signature function such as RSA or ECDSA.

Moreover, certain implementations exploiting the commutativity of the two encryptions make it possible to carry out computing operations with increased security, and in particular benefiting from protection against CCA attacks.

Thus, in certain implementations of the method, the first computer is the TEE;
during at least one of the computing loops, referred to as loop J, of index j=J, and preferably in all the loops, the method is executed as follows:
in step S32 of the loop J, in addition to the encrypted data item under first and second encryption, the first computer sends the second computer a signature thereof, as well as another encrypted data item under first and second encryption accompanied by a signature thereof;
in step S33 of the loop J, the server removes the first encryption from the encryption data item under double encryption and from said other data item received in step S32; in a step S0934 of the loop J, the server applies the elementary operation of index J to the two deciphered data items obtained in step S33;
in a step S0934a of the loop J, the server applies the first encryption to the data item obtained (by applying the elementary operation of index J);
the server furthermore computes a computing proof proving that the encrypted data item obtained following step S0934a is indeed the result of the application of the elementary operation of index J to the two data items used as an input for step S0934, and sends the encrypted data item obtained in step S0934a as well as the proof to the TEE;
during a step S0934b, the TEE verifies at least if the proof corresponds to the computing result; and,
if the verification result is positive, in a step S0936, the first computer removes the second encryption from the data item, and supplies the data item obtained as an input for a step S31 of the following index loop where applicable; if the verification result is negative, the TEE interrupts the processing.

The verification performed during the loop K makes it possible to detect a CCA attack taking place during the loop J.

Furthermore, in certain variants of these implementations, in a step S31b of the loop J, the first computer obtains signatures for two encrypted data items computed in step S31 performed for the iteration j=J or in a previous iteration;
in step S32 of the loop J, the first computer also sends the signatures of said two encrypted data items to the second computer;
after computing the computing proof during the loop J, the second computer returns the two input data items and their respective signatures to the first computer; and the verification performed in step S34b includes, for each of the two data items thus returned to the first computer with their signatures, a verification that each of the data items corresponds to its signature.

Thanks to the verification operation, performed preferably in a TEE, the validity of the computing carried out by the server can be ensured for the client with a lower additional cost than with conventional protocols.

Certain alternative implementations above, also aimed at carrying out computing operations more securely against CCA attacks, use adapted encryption schemas, such as the Paillier encryption schema.

In these alternative implementations of the method, the first computer is the TEE;
the first computer is the TEE;
the second encryption being a homomorphic encryption ensuring security against CCA attacks, for example Paillier encryption;
during at least one of the computing loops, referred to as loop J, of index j=J, the method is executed as follows:
in step S32 of the loop J, in addition to the encrypted data item under first and second encryption, the TEE sends the server another encrypted data item ([z′]_{11,2}) under first and second encryption;
in step S33 of the loop J, the server removes the first encryption from the encryption data item under double encryption and from said other data item received in step S32; in a step S1134 of the loop J, the server applies the elementary operation of index J to the two deciphered data items obtained in step S33;
in a step S1134a of the loop J, the server applies the first encryption to the data item obtained by applying the elementary operation of index J in step S1134; the server sends the encrypted data item obtained in step S1134a to the TEE; and,
in a step S1136, the TEE removes the second encryption from the data item (Dec_{CF}), and supplies the data item obtained as an input for a step S31 of the following index loop where applicable.

In the implementations described above, thanks to the verifiable cryptographic schema, it is then possible to perform the verifications described above systematically, for each of the operations of the combination of elementary operations (unless this verification is not necessary for certain types of elementary operations, for example for additions).

In this case, this systematic verification makes it possible to provide proof that the computing performed benefits from CCA security.

### BRIEF DESCRIPTION OF THE FIGURES

Other advantages, aims and particular features of the present invention will appear from the following non-limiting description of at least one particular embodiment of the devices and methods according to the present invention, with reference to the appended drawings, wherein:

FIG. 1 is a schematic perspective view illustrating a first and a sixth implementation of the invention;

FIG. 2 is a schematic perspective view illustrating a second and a third implementation of the invention;

FIG. 3 is a schematic perspective view illustrating a fourth implementation of the invention;

FIG. 4 is a schematic perspective view illustrating a fifth implementation of the invention;

FIG. 5 is a schematic perspective view illustrating a sixth implementation of the invention;

FIG. 6 is a schematic perspective view illustrating a seventh implementation of the invention;

FIG. 7 is a schematic perspective view illustrating an eighth implementation of the invention;

FIG. 8 is a schematic perspective view illustrating the steps of supplying input data, for a ninth implementation of the invention;

FIG. 9 is a schematic perspective view illustrating the computing steps, for the ninth implementation of the invention;

FIG. 10 is a schematic perspective view illustrating the steps of supplying input data, for a tenth implementation of the invention;

FIG. 11 is a schematic perspective view illustrating the computing steps, for the tenth implementation of the invention; and

FIG. 12 is a flowchart showing schematically the steps of an implementation of a method according to the present disclosure.

### DETAILED DESCRIPTION OF THE INVENTION

By way of non-limiting embodiment examples, different implementations of the data processing method according to the present disclosure will now be described.

Each of these implementations involves the following three entities: a group of at least a client, a server and a TEE.

Any type of computer can be considered as forming the server. However, the server is preferably a computer having high computing capacities.

In the data processing method according to the present disclosure, each of the computers executes its assigned processing operations on encrypted data. These data are encrypted with an encryption indecipherable by the computer, such that it does not have access to the information contained in these data. This encryption can in particular be a homomorphic encryption or a masking encryption.

The encryption and deciphering functions are annotated respectively Enc_{XX}1, Enc_{YY}2, . . . and respectively Dec_{XX}1, Dec_{YY}2, . . . , where ‘1’, ‘2’ are indices; XX and YY indicate the type of encryption used: for example HE for a homomorphic encryption, S for a symmetric encryption, and M for a masking encryption.

The encrypted data are annotated between square brackets in the form [x]₁, where ‘1’ is the index of the encryption function used (here: Enc1). The notation [x]_{1,2} indicates a data item x which has been encrypted successively with the first encryption function Enc1, followed by the second encryption function Enc2.

The steps of the method, in the different implementations described, are annotated in the form Sffnn, where ff refers to the number of the figure wherein the implementation is described, and nn is a step number assigned to the step in question. In the different implementations described, as much as possible, corresponding steps bear the same step number.

Each of the implementations described is aimed at obtaining a result, F(x) or F(x,y), which can be obtained (or equivalently, which is calculable) by applying a function F to at least one input data item x, or in certain cases to several input data items x, y, etc., as in the third implementation described hereinafter with reference to FIG. 3.

This function F is broken down into a certain number of elementary computing operations, or elementary operation (each potentially having any level of complexity).

In the examples developed here, these elementary operations are represented by functions, annotated here f, g, h, or also gj for the case where a function (gj) is invoked iteratively, in a loop, by the computing method.

Naturally, the data processing method proposed is applicable to functions F that can be broken down into elementary operations f such that they can be transposed and executed by computer on the ciphertexts of the data. This condition is not limiting if the encryption schema is a fully homomorphic encryption, but must be taken into account in other cases, for example for a merely partially homomorphic encryption, for example merely additive or multiplicative.

### 1^{st} Implementation—General Case

In a first implementation of the method described by way of example, it is sought to compute a result F(x) using an input data item x supplied by a client CL1.

In this implementation, the function F is broken down into two elementary operations f and g: F(x)=f(g(x)).

To compute F(x), the following operations are carried out:

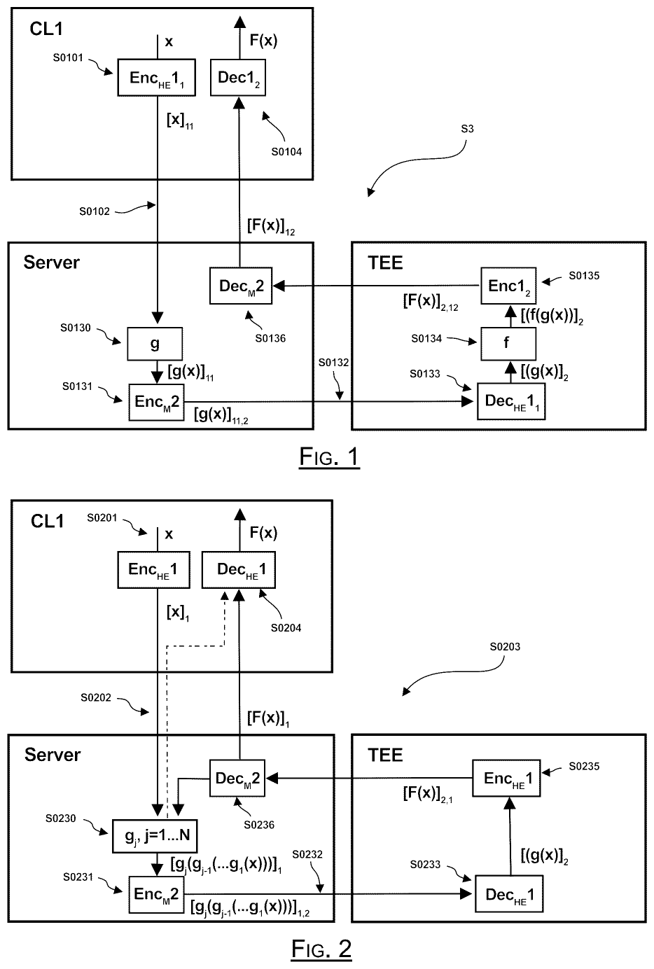

In step S1 (step S0101, in FIG. 1), the client CL1 supplies the data item x.

The client CL1 then applies a first encryption Enc1₁ to the data item x; in this example, Enc1₁ is a fully homomorphic encryption.

In step S0102, the first client CL1 sends the data item [x]₁₁, encrypted under encryption Enc1₁ to the server.

As the data item [x]₁ is encrypted under the encryption Enc1₁, the deciphering key of which is unknown to the server, the server is incapable of accessing the information contained in the data item [x]₁.

In step S0130, the server carries out a first elementary operation, g, consisting of applying a function g to the received data item [x]₁₁, and thus obtains the data item g([x]₁₁). When the encryption Enc1₁ is commutative (in the sense of the composition function o) with the function g, this value is equal to [g(x)]₁₁, as shown in FIG. 1. This is the case for example when the encryption Enc1₁ is an FHE encryption, taking into account the convention whereby the function g applied to the plaintexts and the function g applied to the corresponding homomorphic ciphertexts are both annotated g.

Then in step S31 (S0131), the server applies a second encryption, Enc2, to the data item [g(x)]₁₁, which therefore becomes the data item [g(x)]_{11,2}.

When the first encryption Enc1₁ is a fully homomorphic encryption, any type of encryption may be used as second encryption Enc2.

In the implementation shown in FIG. 1, the first encryption Enc1₁ is a fully homomorphic encryption, and the second encryption Enc2 is a masking encryption. Applying the secondary encryption therefore consists of adding a mask m to the current data item [g(x)]₁₁. The result is therefore the data item [g(x)]_{11,2}, where [g(x)]11,2=[g(x)]₁₁⊗m, the function ⊗ being an addition of a plaintext and a ciphertext.

In step S32 (S0132), the server sends the data item [g(x)]_{11,2}, encrypted under double encryption Enc1₁ and Enc2 to the second computer, the TEE.

As the data item [g(x)]_{11,2} is encrypted under the second encryption (i.e. masked), the TEE is incapable of accessing the information contained in this data item.

In step S33 (S0133), the TEE removes the first encryption (removes the layer of homomorphic encryption) from the data item [g(x)]_{11,2}, and thus obtained a data mask [g(x)]₂, still masked by the mask m.

In most of the variants of this implementation, the computing method then continues with the TEE carrying out step S0135 (described hereinafter), based directly on the data item [g(x)]_{1,2}.

However, an intermediate computing step S0134 of applying a function f to the data item [g(x)]₂ produced by the operation S33 can be provided when the function f and the second encryption/deciphering function (generally, by masking) are commutative for the function composition law (function ‘o’; f o g (.) is also annotated f(g(.))).

In this case, as shown in FIG. 1 in an intermediate step S0134 the TEE applies the function f to the received data item [g(x)]₂. The data item [f(g(x))]₂ is thus obtained.

It is assumed hereinafter by way of example that in the implementation described, step S0134 is carried out.

In step S0135, the TEE applies an additional encryption Enc1₂ (a homomorphic encryption) to the data item [f(g(x))]₂, and thus obtains the intermediate encrypted data item [f(g(x))]_{2,12}, which it sends encrypted under double encryption (homomorphic and masked encryption) to the server.

In step S0136, the server then removes the second encryption by applying the deciphering function Dec2 applied to the intermediate encrypted data item [f(g(x))]_{2,12}, i.e. by removing the mask m, and obtained an intermediate encrypted data item [f(g(x))]₁₂ under the additional encryption Enc1₂.

The server then ends step S3 (S0103) by sending the encrypted result [F(x)]₁₂, to the client CL1.

In step S0104, the client CL1 deciphers the encrypted result [F(x)]₁, i.e. applies the deciphering function Dec1₂ to it, and thus obtains the result F(x).

In this implementation, the second computer is a TEE. As the second computer must be capable of removing and applying homomorphic encryption (in steps S0133 and 0135), the choice of a secure computer such as a TEE as second computer makes it possible to carry out the encryption/deciphering functions Enc1₂ and Dec1₂, using for example a pair of symmetric keys, which makes it possible to execute these functions under satisfactory security conditions.

The additional encryption Enc1₂/Dec1₂ can be the same encryption as the first encryption Enc1₁/Dec1₁, with the same encryption key or not. It can also consist of two different encryptions.

In this implementation, the TEE removes the homomorphic encryption (Dec_{HE}11, step S0133) and applies the additional encryption (Enc1₂, step S0135): these are two examples of support functions applied by the TEE. Step S0133 contributes to the execution of homomorphic computing operations by the server. Step S0135 serves to encrypt results sent to the client. It is noted that the server also carries out support functions, for example in step S0136. Moreover, in this embodiment, in step S0134, the TEE carries out an elementary operation, which is not a support function.

### 2^{nd} Implementation

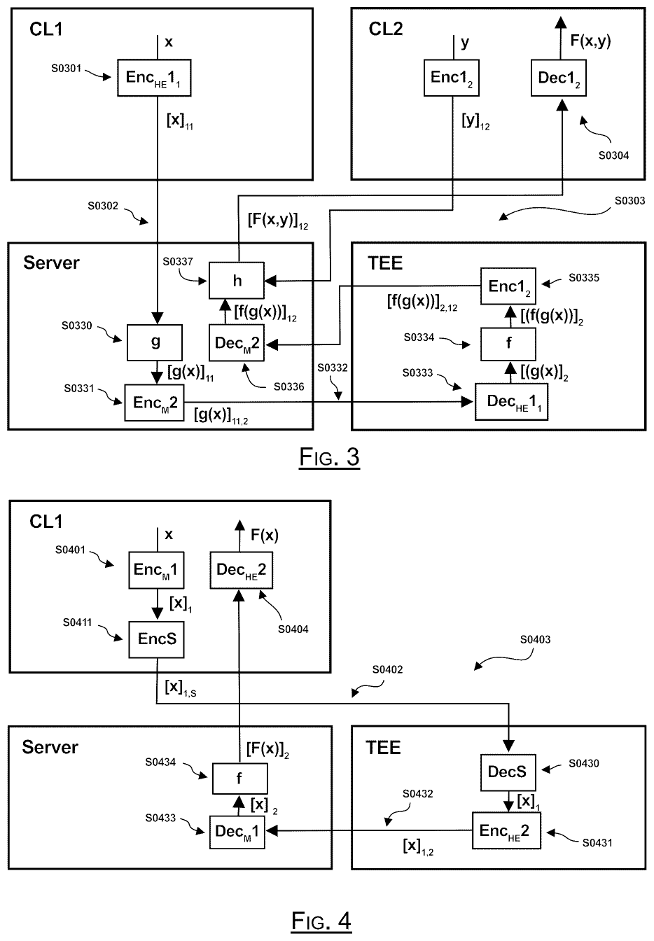

In the second implementation, illustrated by FIG. 2, it is also sought to compute a result F(x) using an input data item x supplied by a client CL1.

In this second implementation, the function F to be computed is broken down into a plurality of elementary operations gj, where j=1 . . . N, as follows:

$$F ( x ) = {g}_{N} ( {g}_{N - 1} ( {g}_{N - 2} ( … ( {g}_{1} ( x ) ) ) ) ) )$$

The elementary operations gⱼ are applied successively to the current data item iteratively by repeating a computing loop N times.

In each iteration of index j, the first computer, the server, applies an elementary function gⱼ to the current processed data item gⱼ₋₁ (gⱼ₋₂ (gⱼ₋₃ ( . . . (g₁(x)))))). To simplify, in the present document, the processed data item gⱼ (g_{j-1 (}gⱼ₋₂ ( . . . (g₁(x)))))) conventionally is annotated gⱼ(x).

As the number of elementary operations gⱼ to be applied can be very high, it may be necessary for certain encryption schemas to reset the noise periodically. This relates in particular to the case where the first encryption is a homomorphic encryption wherein a noise component is integrated in the homomorphic ciphertext: it is then necessary periodically to reset the noise (so-called ‘Bootstrapping’ operation) (for more details, refer to Ref.2).

This second implementation of the method provides a solution for this reset. The TEE in this case advantageously is used to carry out the reset operation. In each iteration, the server applies an elementary function gⱼ to the data item, and the TEE performs a noise reset operation.

The operations carried out in the second embodiment are the same as those performed in the first implementation apart from the following points:

The main difference is that, as the function F is broken down into N elementary operations gⱼ, following step S0236 of removing the second encryption (removing the mask m)(comparable to the function S0136 of the first implementation), in the second implementation, there are two possibilities:

If the index j is strictly less than N, the ciphertext [gⱼ (gⱼ₋₁ (gⱼ₋₂ ( . . . (g₁(x))))))]₁ computed in step S0236 by the server is then supplied as an input data item for the following iteration of the computing loop (composed of steps S0230, S0231, S0232, S0233, S0235, S0236).

Conversely during the last iteration, wherein the index j is equal to N, the ciphertext [g_{N} (g_{N-1} (g_{N-2} ( . . . (g₁(x))))))]₁ computed in step S0236 by the server, and equal to the ciphertext of the result [F(x)]₁, is then sent to the client CL1. This then deciphers this ciphertext and thus obtains the result (step S4).

However, in one variant, during the last computing loop (j=N), once step S0230 is carried out, instead of carrying out steps S0231, S0232, S0233 and S0235 to allow the noise reset operation, the server sends the result obtained in step S0230 directly to the client CL1 (dotted arrow in FIG. 2). The client can then remove the first encryption from the result sent and thus obtain the result of the computing F(x).

In each iteration, the elementary computing operation S0230 (application of a function gⱼ) by the server is therefore followed by noise reset operations S0233 and S0235 by the TEE.

The function of the TEE is therefore only to remove then reapply homomorphic encryption, by applying the functions Dec_{HE}1 and Enc_{HE}1, which are two support functions: unlike the first implementation, the TEE only carries out support functions, and does not carry out an elementary computing operation f; there is no comparable step to step S0134.

Advantageously, in particular in encryption schemas based on the LWE problem, the encryption and deciphering operations can be extremely fast, which means that the processing operations (operations S0233, S0235) carried out by the TEE only slow down the computing operations carried out by the server negligibly.

In certain implementations, the mask m is a mask supplied to the server by the client CL1 in a keystream. In this case, the second encryption performed in step S0231 in each iteration of index j uses a mask mⱼ having a specific value in the iteration of index j.

### 3^{rd} Implementation

A third implementation, also illustrated by FIG. 2, includes the same operations as the second implementation.

The difference between the second and the third implementation is that whereas in the second, the TEE carries out a noise reset operation, by contrast in the third implementation, the TEE carries out a relinearisation of the encrypted data item [gⱼ (gⱼ₋₁ (gⱼ₋₂ ( . . . (g₁(x))))))]_{1,2}.

This relinearisation advantageously makes it possible to modify the encrypted data item: the relinearisation operation makes it possible to restore the form of the encrypted data item, and return it to the form of the initial ciphertexts or ‘fresh ciphertexts’. The TEE advantageously is used to perform the relinearisation operation.

The encryption schemas for which a relinearisation is required can in particular be LHE (‘Levelled Homomorphic Encryption’) level type schemas, such as BGV and BFV for example.

### 4th Implementation

A fourth implementation, illustrated by FIG. 3, corresponds to a case where the computing to be performed is a function F of several variables, supplied respectively by two clients (or users) or more.

In the example, only the case of two variables x and y supplied respectively by two clients CL1 and C2L has been considered, but the method is applicable to any number of variables, supplied respectively by any number of clients CL1 . . . CLN.

In the example described, the function F is broken down into elementary operations as follows: F(x,y)=h(f(g(x)),y)).

The operations carried out in this embodiment are the same as those performed in the first implementation apart from the following points:

During the initial operation S1 (S0301), two clients CL1 and CL2 (and not only the client CL1) supply an input data item, respectively x and y, for data processing.

Each of these two data items is encrypted: A first encryption Enc1₁ is applied to x by the client CL1, and another ‘first encryption’ Enc1₂ is applied to y by the second client. The encryptions Enc1₁ and Enc1₂ are different or not from each other; they can also have the same encryption schema, but with different keys.

The encrypted data obtained [x]₁₁ and [y]₁₂ are then sent to the server (step S0302).

The following operations S0330, S0331, S0332, S0333, S0334, S0335 and S0336 are then substantially identical to the operations of the same step number performed in the first implementation.

It should be noted however that in step S0335, the first encryption applied is that used by the second client CL2, so as to prepare the supply to this second client, at the output of the server, of a processed data item encrypted under the first encryption Enc1₂ which is that used by the client CL2.

Moreover, following step S0336, instead of the result being sent directly to the client (CL2) (as in step S0136), an elementary operation h is previously applied (step S0337). This operation h uses as input data the encrypted data item [f(g(x))]₁₂ and the encrypted data item [y]₁₂, and supplies as an output a ciphertext of the result [F(x,y)]₁₂.

This ciphertext of the result [F(x,y)]₁₂, is then sent to the client CL2. This then deciphers this ciphertext and thus obtains the result (step S4).

In this example, the variable y is only involved in a computing phase wherein the variable x has already undergone two successive processing operations g and f, having made it possible to obtain f(g(x)). That being said, naturally any form is possible for the function F; in particular the variable y could be combined with the variable x from the first computing phase.

Moreover, in this implementation, the function g is applied to the data item x in a first elementary operation carried out by the server, and is followed by a second elementary operation f carried out by the TEE. The third elementary operation is once again an operation carried out in the server.

It is understood that as a general rule, any distribution of elementary operations between the two computers can be envisaged. Thus the data item processed in each of the computers can be dependent on all or part of the input variables (x and y in this example). Furthermore, although this is not the case in this implementation, in certain implementations, the computing can involve iterative computing operations between the two computers, as in the implementation illustrated by FIG. 2.

The specificity of the fourth implementation, besides the fact that several input data items are supplied by the different clients (CL1 and CL2) at the input of the method, is that the method makes it possible to carry out a transencryption when the encryption schema Enc1₁/Dec1₁ is different from the schema Enc1₂/Dec1₂. The method makes it possible that using an encrypted data item x as an input with the homomorphic encryption schema Enc1₁, the client CL2 which receives the result as an output receives the result encrypted with another encryption schema, the schema Enc1₂/Dec1₂. It will be noted that the second client CL2 could optionally be the client CL1, then having two encryption schemas.

While in this implementation, the homomorphic encryption schemas use pairs of asymmetric keys, the TEE uses the private key of the homomorphic encryption schema Enc_{HE}1₁; and to encrypt the data item under encryption Enc1₂ in step S0335, the TEE has the public key of the encryption schema Enc1₂ and does not need the private key of the client CL2.

### 5th Implementation

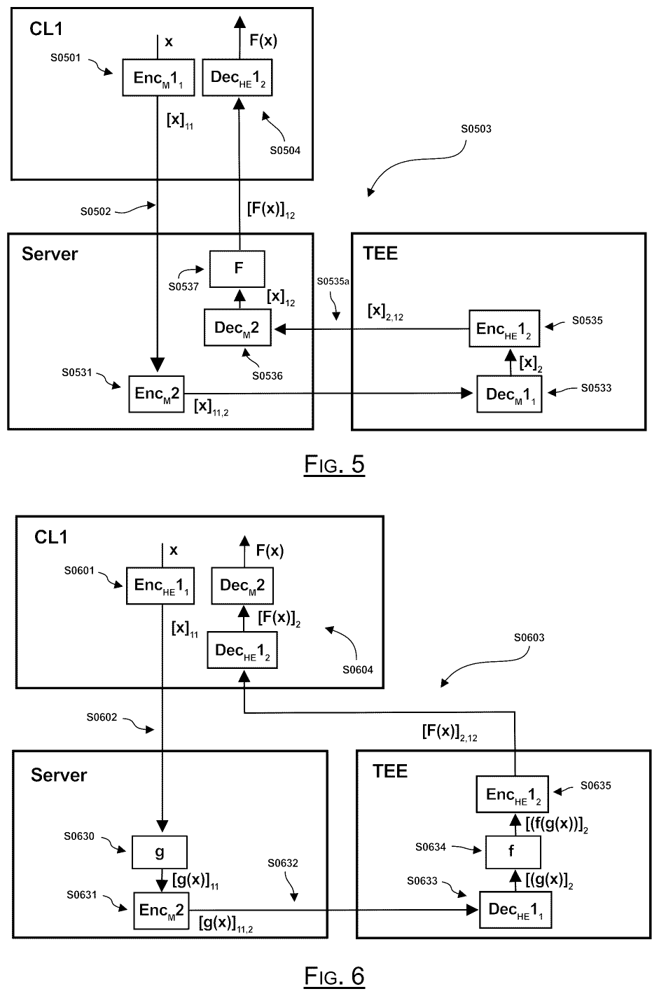

In a fifth implementation, illustrated by FIG. 4, it is sought to compute a result F(x) of a function F which only requires applying an elementary operation f.

The operations carried out in this embodiment are the same as those performed in the first implementation apart from the following points:

Firstly, in step S1 (S0401), the client CL1 after applying the first encryption Enc_{M}1, which is a masking encryption, applies another encryption Enc_{S}. In this implementation, this other encryption is a symmetric encryption (Enc_{S},Dec_{S}), which represents neither the first encryption nor the second encryption in the sense of the present disclosure. This symmetric encryption Enc_{S} is an additional encryption, used to guarantee the confidentiality of the data item sent with respect to the server. Although the data item [x]_{1,s} in this implementation sent directly by the client to the TEE (as the first computer), in other implementations, this data item can be sent via the server (in particular because in practice the TEE is most often integrated in the server).

After successively applying the first encryption Enc_{M}1 and the symmetric additional encryption Enc_{S}, the client CL1 sends the encrypted data item [x]_{1,s} to the first computer, which is the TEE and not the server, unlike the first implementation.

On receipt of the data item [x]_{1,s}, the TEE firstly removes the symmetric encryption (by applying the function Dec_{S})(step S0430).

The following steps S0431, S0432, S0433 and S0434 are then carried out similarly to the stems of the same step numbers of the first implementation (with the important difference that the first computer is now the TEE, and that the second computer is the server):

The TEE applies the second encryption (Enc_{HE}2) to the data item (step S0431) and obtains the data item [x]_{1,2}, which it sends to the server (step S0432).

The server removes the first encryption from the data item (step S0433), then performs elementary operation S0434 during which it applies the function f to the data item [x]₂. This ciphertext of the result [F(x)]₂ is thus obtained, which it sends to the client CL1. The client then removes the second encryption (by applying Dec_{HE}2, operation S4 (S0404) and thus obtains the result F(x).

In this implementation, the first encryption Enc_{M}1 is a masking encryption. Applying this encryption therefore consists of adding a mask m to the data item. In the present case, this therefore consists of replacing the current data item x by the sum x+m. This gives: [x]₁=x+m.

To allow the server to remove this encryption, the mask m is shared between the client CL1 and the server. Conversely, as the data item [x]_{1,s} is encrypted using this mask m before being sent to the TEE, the latter cannot know the content of the processed data item sent to it: masking encryption is indecipherable for the TEE.

Moreover, in order to be able to apply the second, homomorphic, encryption Enc_{HE}2, the TEE has the public key of the latter encryption, the client CL1 having for its part the corresponding private key to be able to remove this encryption (Function Dec_{HE}2).

### 6th Implementation

In the 6th implementation, it is also sought to compute a result F(x) using an input data item x; the function F constitutes per se a single elementary operation F.

This 6^{th} implementation makes it possible, like the 5^{th} implementation, to carry out a transencryption. This implementation is illustrated by FIG. 5.

In this 6^{th} implementation, the operations carried out are substantially identical to the operations of the same step number carried out for the 1^{st} implementation, with nonetheless the following specificities or sometimes differences:

In step S1 (S0501), the first encryption Enc1₁ applied is not a homomorphic encryption, but a masking encryption: The encrypted data item [x]₁₁ is defined by: [x]₁₁=x+m1, where m1 is a first mask which is unknown to the server and therefore indecipherable thereby.

The data item [x]₁₁ is then sent to the server in step S2 (S0502).

In step S31 (S0531), the server applies to the data item a second encryption Enc_{M}2 which in this implementation is also a masking encryption. The data item obtained, [x]_{11,2} is then sent to the TEE (step S0532).

In step S0533, the TEE removes the first encryption (i.e. applies the function Dec1₁, by subtracting the value of the first mask m1).

Then in step S0535, the TEE once again applies an encryption decipherable by the client CL1, namely a fully homomorphic encryption, via a function Enc1₂, and sends the result [x]_{2,12} to the server.

In step S0536, the server removes the second encryption (function Dec_{M}2) and obtains a ciphertext of the processed data item [x]₁₂.

Then, in step S0537, the server applies the function F to the ciphertext [x]₁₂ and obtains the homomorphic ciphertext of the result, [F(x)]₁₂.

It then sends this ciphertext [F(x)]₁₂ to the client, which deciphers it and thus obtains the result F(x) in step S4 (S0504).

### 7^{th} Implementation

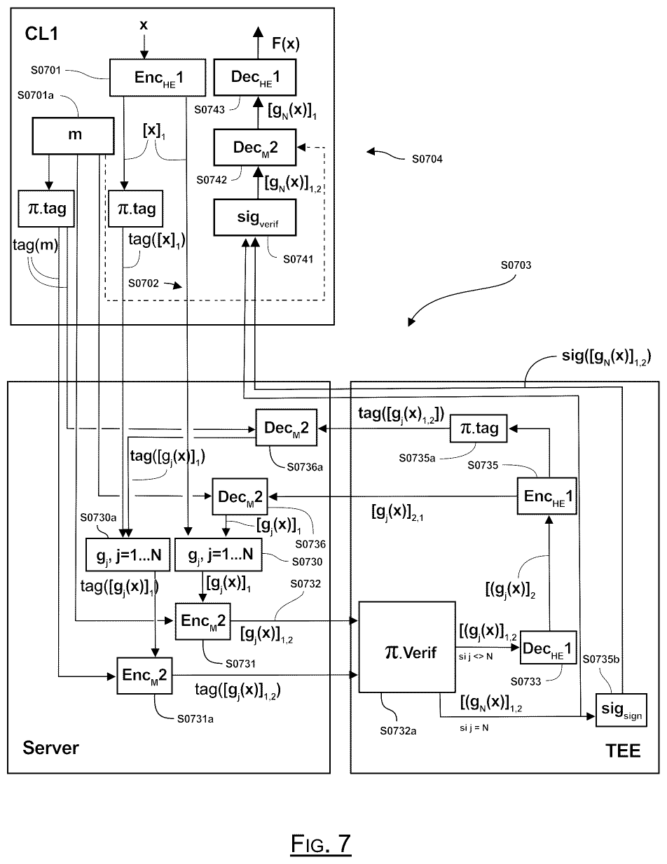

A 7^{th} implementation, illustrated by FIG. 6, makes it possible, as in the 5^{th} and 6^{th} implementations, to carry out a transencryption.

This 7^{th} implementation is similar to the implementation of FIG. 1. Hence, these two implementations can be considered to be identical, except only for the differences which will now be described.

The function F, as in the first implementation, is broken down as follows: F(x)=f(g(x)).

Steps S0601, S0602, S0630, S0631, S0632, S0633, S0634 and S0635 are substantially the same as the steps of the same step numbers of the first implementation, mutatis mutandis.

In particular, step S0634 can only take place if the function f and the second encryption/deciphering function are commutative for the function composition law.

In step S1 (S0601) as in the first implementation, a fully homomorphic encryption is applied by the function Enc_{HE}1₁.

The encryption Enc_{HE}1₂ can in particular be a symmetric encryption.

Furthermore, following step S0635, in the 7^{th} implementation, the TEE sends the encrypted result [F(x)]2,12 directly to the client CL1 (This encrypted result [F(x)]_{2,12} could transit via the server, because the encryption Enc_{HE}1₂ is not decipherable by the latter).

In the 7^{th} implementation, finally, in step S4 (S0604) the client CL1 therefore carries out a double deciphering, firstly by applying the function Dec_{HE}1₂, then by applying the function Dec_{M}2. It thus obtains the result F(x) in plaintext.

### 8^{th} Implementation

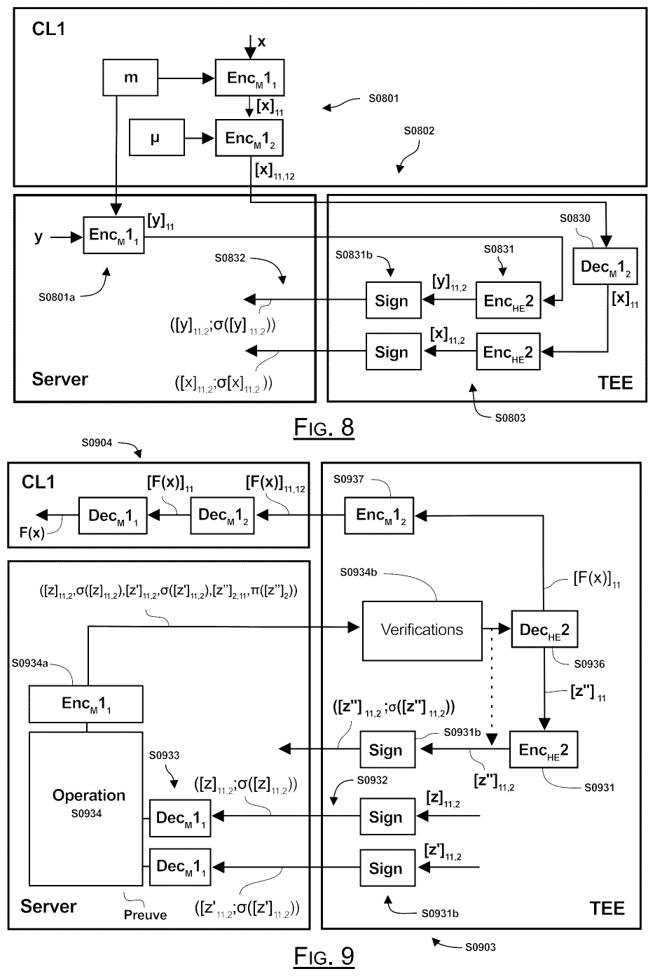

The 8^{th} implementation, illustrated by FIG. 7, relates to the case where it is sought specifically to protect against the case where both the server has a malicious behaviour, and the TEE has an “honest-but-curious” behaviour.

This implementation is applicable when there is for the computing to be carried out a verifiable computing protocol for verifying the results of all the computing operations carried out during the elementary computing operations. In this case, the computing is distributed as follows: the elementary operations are performed by the server, in particular under fully homomorphic encryption; each of these elementary operations is verified by the TEE.

This protocol makes it possible to verify that the computing is executed in a conforming way by performing a verification operation for each of the elementary operations performed.

Examples of verifiable computing protocols are cited for example by document Ref.5.

The integrity of the operations carried out in the TEE can for its part also be guaranteed, using a remote attestation method.

When these measures are adopted, advantageously the computing method makes it possible not only to ensure data confidentiality, but also computing integrity.

An example of implementation of the method, indicating the verifications to be carried out is represented schematically by FIG. 7.

In this implementation as in the 2^{nd} implementation, the function F to be computed is broken down as follows:

$$F ( x ) = {g}_{N} ( {g}_{N - 1} ( {g}_{N - 2} ( … ( {g}_{1} ( x ) ) ) ) ) )$$

Hence, the elementary operations are carried out iteratively by performing the same computing loop N times: each computing step by the server makes it possible to apply, during a loop of index j, an elementary function gⱼ to the current data item gⱼ₋₁ (gⱼ₋₂ (gⱼ₋₃ ( . . . (g₁(x)))))), also annotated conventionally, to simplify, gⱼ₋₁(x).

The operations carried out within the scope of this implementation comprise overall the operations (or steps) of the second implementation, to which additional verification operations are added.

A verification is therefore carried out for each elementary operation, during each of the successive computing loops.

Thus in this implementation, the following operations are carried out:

In step S0701, the client CL1 supplies an input data item x. It computes a ciphertext [x]₁ of this data item x for a first encryption Enc_{HE}1 (Enc_{HE}1 is a fully homomorphic encryption).

The ciphertext [x]₁ is also used to compute a tag of the ciphertext [x]₁ of the input data item, annotated tag([x]₁), referred to as data tag.

A tag denotes here a value, also referred to as a label, which is computed from an initial data item and retained so as to then allow the authentication of the initial data item or keep a record thereof, within the scope of a verifiable computing verification protocol.

The data tag tag([x]₁), like all the tags mentioned here, is computed by a tag computing function π.tag, within the scope of a verifiable computing protocol π. This protocol is determined according to the computing to be carried out in order to allow the verification thereof.

In parallel, during successive steps S0701a, the client CL1 generates an encryption keystream. In each iteration of the computing loop which will be described hereinafter between the two computers, the server and the TEE, the client CL1 generates a new key value mⱼ in a step S0701a. Furthermore, using this key value mⱼ, also in each step S0701a, the client CL1 also computes a key tag tag(mⱼ).

Thus, in each iteration of the computing loop of index j (j=1 . . . N), the client CL1 sends the server the new computed key mⱼ and the associated key tag tag(mⱼ).

Sending the keys mⱼ allows the server to carry out the operations of applying and removing the second encryption (Enc_{M}2, Dec_{M}2) to the processed data item in steps S0731 and S0736 described hereinafter.

Similarly, sending the key tags tag(mⱼ) allows the server to carry out the operations of applying and removing the second encryption (Enc_{M}2, Dec_{M}2) to the data tags in steps S0731a and S0736a described hereinafter.

In step S0702, the client CL1 sends the server the encrypted data item [x]₁ and the data tag tag([x]₁).

On receipt of the received information (encrypted data item [x]₁, tag thereof tag[x]₁, keys mⱼ, key tags tag(mⱼ)), the server and the TEE progressively compute the result F(x) by carrying out N computing loops, as follows in step S3 (S0703).

In each loop of index j (j=1 . . . N), the server carries out an elementary operation gⱼ, by applying a function gⱼ to the processed data item received as an input (step S0730). In the 1^{st} iteration, the data item received as an input is the encrypted data item [x]₁; in subsequent iterations, the data item received as an input in step S0730 is an iteration of index j is an intermediate processed data item [gⱼ₋₁(gⱼ₋₂( . . . g₁(x)))))]₁ computed during a deciphering step S0736 which will be described hereinafter.

In parallel, in a step S0730a, the server once again applies the function gⱼ, but this time it applies it successively, in the 1^{st} iteration, to the data tag tag([x]₁) of the (initial) encrypted data item [x]₁; then, in subsequent iterations of index j, to the successive data tags of the intermediate data tags tag([gⱼ₋₁(gⱼ₋₂( . . . g₁(x)))))]₁), also annotated tag([gⱼ(x)]₁) computed during deciphering steps S0736a which will be described hereinafter.

The tag computing function is commutative with the elementary operations gⱼ; hence, the result can be written indiscriminately as g;(tag([gⱼ₋₁(gⱼ₋₂( . . . g₁(x)))))]₁) or tag([gⱼ(gⱼ₋₁(gⱼ₋₂( . . . g₁(x)))))]₁), also annotated tag([gⱼ(x)]₁).

The result [gj(gj−1( . . . g1(x)))))]₁, also annotated [gⱼ(x)]₁ obtained in step S0730 is then encrypted by masking in step S31, with the mask mⱼ, which constitutes the application of a second encryption (function Enc_{M}2).

In parallel, using the tag (tag[gⱼ(x)]₁)) obtained in step S0730a and the tag tag(mj) of the mask mj, the server computes the tag of the ciphertext under double encryption of the data item (tag([gj(x)]₁₂)) in step S0731a, which requires the application of the second encryption to the processed data item (function Enc_{M}2).

All the data processed by the server which are functions of the input data item x are under first encryption Enc_{HE}1 and hence are indecipherable for the server, which is incapable of accessing the information contained in these data.

The server then sends the TEE in parallel the data item [gⱼ(x)]_{1,2} and the data tag tag([gⱼ(x)]_{1,2}), both under double encryption in step S32 (S0732).

In step S0732a, the second computer, the TEE, then performs a verification of the computing carried out according to the verifiable computing protocol, based in particular on the ciphertext of the data item [gj(x)]_{1,2} and the associated tag tag([gj(x)]_{1,2}).

This verification can in some cases include the following verification: the TEE computes at its end the data tag tag([gⱼ(x)]_{1,2}) using the data item [gⱼ(x)]_{1,2} under double encryption, and verifies that the tag obtained is identical to that received in step S0732.

If the verification result is negative, the data processing is stopped and a warning message is sent.

Conversely, the verification result is positive, the TEE continues the processing.

For loops of index j<N:

If the verification performed in step S0732a indicates that the processing is performed in keeping with expectations, the TEE then removes the first encryption (applies the function Dec_{HE}1) of the data item [gⱼ(x)]_{2,1}, i.e. it subtracts the mask mⱼ, and thus obtained the data item [gⱼ(x)]₂ in step S33 (S0733).

The TEE then once again applies the first encryption (applies the function Enc1) to the data item [gⱼ(x)]₂, i.e. it adds a new mask mⱼ, and thus obtains the data item [gⱼ(x)]_{2,1} (step S0735).

The TEE then sends this data item to the server as an input data item to allow the execution for the index j+1 of step S0736.

In step S0736 (in the loop of index j+1), the server removes the second encryption (applies the function Dec_{M}2) of the data item [gⱼ(x)]_{2,1} and therefore obtains the data item [gⱼ(x)]₁, which will serve as input data item for step S0730 of the next iteration.

In parallel, following step S0735, the TEE computes a new data tag tag([gj(x)_{1,2}]) (step S0735a). It then sends this tag tag([gj(x)_{1,2}]) to the server as an input data item for the execution of step S0736a for the loop j+1.

In step S0736a (in the loop of index j+1), the server computes the data tag for the unmasked data item (from which the second encryption has been removed by applying the function Dec_{M}2) using the received data tag tag([gⱼ(x)]_{1,2}.

The current index of the computing loop then switches to j+1.

The computing loop of index j+1 then starts by executing in parallel steps S0730 and S0730a, on the basis respectively of the data item [gⱼ(x)]₁ and the data tag tag([gⱼ(x)]₁).

During the Loop of Index j=N

If the index j is equal to N, at the end of step S0732a, the server sends the client CL1 the data item [g_{N}(x)]₁₂, i.e. [F(x)]₁₂.

In parallel, once step S0732a has been carried out, during a step S0735b, using the data item [g_{N}(x)]_{1,2} obtained and verified in step S0732a, the TEE computes a signature sig([g_{N}(x)]_{1,2}) of the data item obtained, and sends it to the client CL1 (optionally, via the server). This signature is computed so as to make it possible to prove that the returned encrypted data item is indeed the encrypted data item obtained, once all the constituent elementary operations of F have been performed.

This signature as well as the data item [g_{N}(x)]_{1,2} are therefore sent to the client CL1, optionally via the server.

The client CL1 then carries out step S4 (S0704), which includes three sub-steps S0741, S0742 and S0743.

In step S0741, the client CL1 verifies using the signature sig([g_{N}(x)]_{1,2}) that the returned encrypted data item [g_{N}(x)]_{1,2} is indeed the encrypted data item expected following the computing operations. If the verification result is positive, computing is continued in step S0742; otherwise, it is interrupted and a warning message is sent.

In step S0742, the client CL1 removes the second encryption from the data item and obtains the data item [g_{N}(x)]₁.

In step S0743, the client CL1 deciphers the data item received [F(x)]₁, i.e. removes the first encryption therefrom, and thus obtains the result F(x)=g_{N}(x).

In this implementation, the TEE only carries out support functions. Indeed, the tag computing and verification functions applied during steps S0732a and S0735a are functions serving to verify the homomorphic computing operations carried out by the server; the deciphering/encryption functions carried out in steps S0733 and S0735 are functions contributing to the execution of the homomorphic computing operations by the server; and the signature computing function carried out in step S0735b is a function serving to prepare a verification data item serving to verify the results sent to the client CL1.

### 9^{th} Implementation

A 9^{th} implementation relates to the case where it is sought to carry out the computing securely in relation to a Chosen Ciphertext Attack (CCA).

In this aim, the method is implemented in two phases illustrated respectively by FIGS. 7 and 8.

A 10^{th} implementation will subsequently be described, which makes it possible to secure the processing in the same way, but this time using the Paillier cryptosystem.

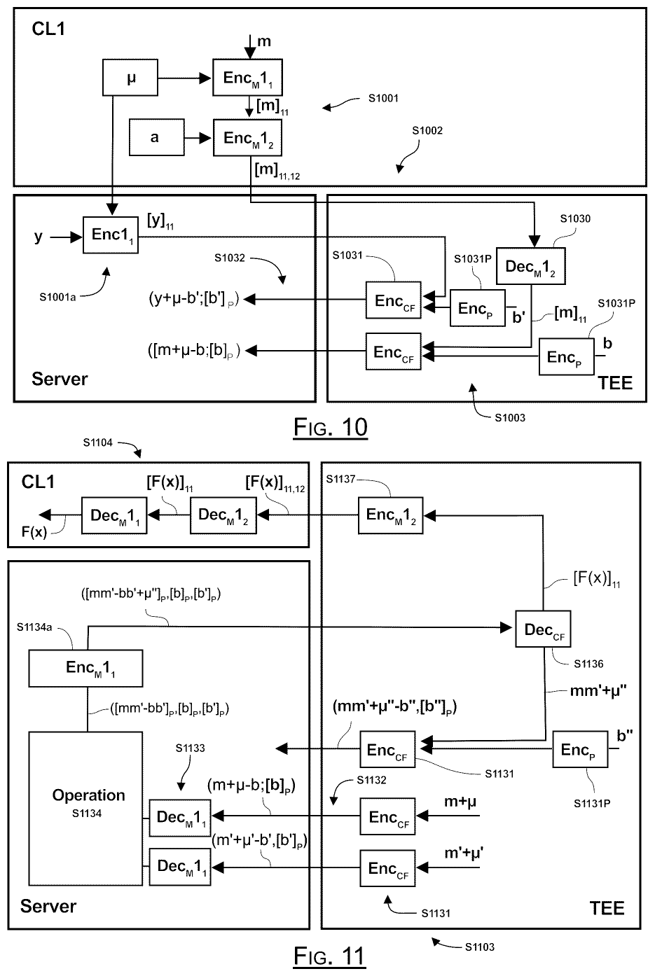

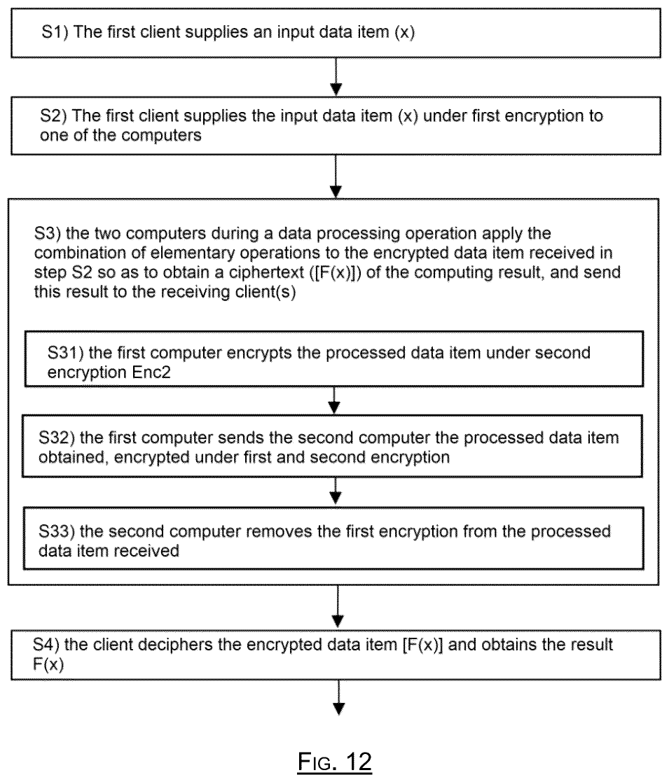

For the 9^{th} implementation firstly, FIG. 8 shows the preparation of input data with a view to data processing and FIG. 9 shows the main data processing steps.

The preparation phase includes the following steps:

In step S1 (S0801), the client (emitting client) CL1 supplies a data item x to serve as input data item for the computing.

It applies a first encryption Enc_{M}1₁ to it, by masking, in this instance by adding a first mask m1.

It then applies an additional encryption Enc_{M}1₂ to it, also by masking, by adding a second mask m2. This additional encryption Enc_{M}1₂ is neither a first nor a second encryption in the sense of the present disclosure. As in the 5^{th} implementation, this encryption Enc_{M}1₂ is an additional encryption used to guarantee the confidentiality of the data item sent with respect to the server. In this implementation, the encrypted data item obtained following the two encryption steps is sent by the client to the TEE (as the first computer) via the server, which justifies the need for this encryption Enc_{M}1₂ indecipherable by the server (the encryption Enc_{M}1₁ being for its part indecipherable by the TEE).

In step S2 (S0802), the client CL1 sends the data item [x]_{11,12} under double encryption to the first computer, the TEE (The TEE is indeed the first computer because it is the computer which will encrypt the data item under a second encryption in step S31, the server conversely in step S2 only sending the TEE the data item received from the client).

Then in step S3 (S0803), using the data item received in step S2, the server and the TEE compute a ciphertext [F(x)] of the computing result, and send this result to the receiving client which is the client CL1.

In step S4 (S0904) the client CL1 deciphers the ciphertext of the computing result [F(x)] and obtains the sought result F(x).

Step S3, represented essentially in FIG. 9, is performed iteratively and is represented by FIGS. 8 and 9.

The function F, in this implementation, includes a certain number of input data items. In the example described, only the supply of two input data items x and y to the computing process has been represented in FIG. 8, but as a general rule, any number of input data items can be supplied to the computing process, optionally by a plurality of emitting clients, in particular during successive computing loops forming part of the data processing.

As stated, FIG. 8 represents the preparation of input data items x and y for data processing. The data item x is a data item supplied by an emitting client CL1. The data item y is a data item supplied by the server (which can hold it from any source or compute it by any means).

Before being sent to the TEE, the data item y is previously encrypted under the first encryption Enc1₁ by the server in step S0801a.

The data items [x]_{11,12} and [y]₁₁ are sent to the TEE, respectively by the client CL1 and the server.

On receipt of the data item [x]_{11,12}, the TEE removes the additional encryption (applies Dec1₂), i.e. removes the mask m2 from it (step S0830).

In step S31 (S0831), in parallel, the second encryption Enc_{HE}2, a fully homomorphic encryption, is applied to the data items [x]₁₁ and [y]₁₁.

The data under double encryption obtained [x]_{11,2} and [y]_{11,2} are then signed (step S0831b).

The data under double encryption [x]_{11,2} and [y]_{11,2} and their signatures G([x]_{11,2}) and a([y]_{11,2}) are sent respectively to the TEE in step S32 (S0832).

These data serve as input data for the elementary operations carried out in a loop, during successive iterations, by the server in conjunction with the TEE, as shown in FIG. 9.

In FIG. 9, this time, the supply of two input data items [z]_{11,2} and [z′]_{11,2} has been represented. These data can be data produced during step S31 (S0831) illustrated in FIG. 8, whether they are data x supplied by the emitting client, and/or data y supplied by the server. As will be explained, they can also be data such as the data item [z″]_{11,2} computed during step S31 (S0831) represented in FIG. 8 of the data processing process per se.

Therefore, the case where two input data items [z]_{11,2} and [z′]_{11,2}, each under double encryption Enc_{M}1₁ and Enc_{HE}2, are supplied as an input to the TEE is considered. The first encryption is a masking encryption: the data item z is encrypted with the mask m and the data item z′ with the mask m′.

The TEE computes signatures a([z]_{11,2}) and a([z′]_{11,2}) for these data (step S0931b). Each of these data in conjunction with its signature is then sent to the server in step S32 (S0932).

In step S33 (S0933), the server removes the first encryption from these data and their associated signatures by applying Dec_{M}1₁.

It then carries out an elementary computing operation (operation S34). This operation can for example be the multiplication of the two data items z and z′, i.e. computing of a new data item [z″]₂=[z]₂*[z′]₂. This multiplication is carried out between homomorphic ciphertexts.

Using any known computing integrity proof method, a proof π([z″]₂) of the integrity of the elementary computing operation performed in step S34 is then computed.

This proof confirms that there are masks (m, m′, m″), applied to the data (z, z′, z″), such that

$${{{[ z - m ]}_{2} * [ z ’ - m ’ ]}_{2} = [ z ” m ” ]}_{2}$$

where * represents the multiplication operation between homomorphic ciphertexts under encryption Enc2.

The encrypted data item [z″] is then encrypted again under the encryption Enc_{M}1₁ (step S0934a): a mask m″ is added to it.

Following the encryption operation performed in step S34a, the following elements are sent to the TEE with a view to a verification operation S0934b: The input data of the operation S34 and their signatures, i.e. [z]_{11,2}, [z′]_{11,2}, a([z]_{11,2}), a([z′]_{11,2}); and the data obtained as an output: [z″]_{2,11}, π([z″]₂).

On receipt of these elements, in step S0934b, the TEE performs the following verifications: it verifies the authenticity of the first data item [z]_{11,2} in relation to its signature a([z]_{11,2}), the authenticity of the second data item [z′]_{11,2} in relation to its signature a([z′]_{11,2}), then verifies the authenticity of the data item obtained as an output [z″]₂ with respect to the proof of the result, π([z″]₂). (Further verifications can be performed according to the security constraints to be observed by the data processing method).

If the result of these three verifications is positive, the TEE removes the second encryption from the data item [z″]_{11,2} (Dec_{HE}2, operation S0936).

The processing subsequently applied is dependent on whether the elementary operations are completed or not:

In the first case, i.e. if the index j is strictly less than N, the set of elementary operations (function gⱼ) has not been performed completely. The data item [z″]₁₁ under first encryption is again encrypted under second encryption Enc_{HE}2, homomorphic encryption, to allow the continuation of the data processing (step S0931).

After having applied the second encryption Enc_{HE}2 again in step S0931, the TEE signs the result [z″]_{11,2} (operation S0931b) and sends the server for the remainder of the calculations the data item [z″]_{11,2} under double encryption and its signature.

Conversely, if the index j is equal to N, the data item [z″]₁₁ under first encryption is the computing result [F(x)]11, encrypted under first encryption. This result is re-encrypted under the additional encryption Enc_{M}1₂ (step S0937), then is sent under double encryption to the client. Applying the additional encryption Enc_{M}1₂ guarantees that the result sent to the client cannot be understood by the server. This result can therefore optionally be sent via the server.

During the different loops, thanks to the successive operations of the support functions Dec_{HE}2 and Enc_{HE}2 for removing and applying the second, homomorphic, encryption (operations S0936 and S0931), the noise level is reduced in the encrypted result [z″]_{11,2} ultimately re-sent to the server, which allows the continuation of the computing iterations.

In the second case above (j=N), on receipt of the result [F(x)]_{11,12} under double encryption, the client removes the additional encryption (Dec1₂) and the first encryption (Dec1₁) and thus obtains the result F(x) in step S4 (S0904). As the second encryption, i.e. the homomorphic encryption, has been removed by the TEE, this avoids the client doing so: the client only has to carry out much simpler operations of removing masks (Dec 1₁ and Dec 1₂).

Note: In another simpler embodiment, following the verifications, the TEE does not remove the second encryption (does not carry out the operation Dec_{HE}2): Following the verifications performed in step S34b (or even without carrying out these verifications), the TEE computes a signature of the result a([z″]₂) (step S0931b) then returns the result [z″]₂ and its signature a([z″]₂) to the server. This consists of bypassing steps S0936 and S0931: this method is illustrated by the dotted arrow on the right-hand section of FIG. 9.

Advantageously, in this implementation, the data exchanged between the client and the server are not encrypted homomorphically.

The verifications only relate to elementary operations, which are generally simple (for example: a multiplication). Hence, the second encryption may not be fully homomorphic (in that an encryption making it possible to perform an arbitrary number of successive additions and multiplications i.e. arbitrary multiplicative depth would be referred to as fully homomorphic encryption). Thus for example, a second encryption which is a homomorphic encryption of depth 1 (or of any finite depth) can be used in this implementation.

In this implementation, the verifications performed make it possible to prove, step by step, that all the ciphertexts handled during the computing operations are either computed by the TEE (which, as the owner of the secret second encryption key, is not an attacker for the second encryption), or computed during legitimate homomorphic computing operations performed on ciphertexts computed by the TEE (in the ‘Proof’ dotted rectangle in FIG. 8). Therefore, there is no possible CCA adversary on the FHE layer, because an adversary (here, optionally, the server) is not capable of generating homomorphic ciphertexts which would not be duly produced by the encryption function or derivatives of such ciphertexts by legitimate homomorphic operations.

### 10^{th} Implementation

The 10^{th} implementation will now be described with reference to FIGS. 10 and 11. In this implementation, the Paillier schema is used to carry out the elementary multiplication operations between ciphertexts under second encryption in step S34; however, it can only be implemented for computing operations of multiplicative depth 1.

Advantageously, as the Paillier schema intrinsically provides security against CCA attacks, it is no longer necessary in this implementation to use signature and signature verification operations as in the implementation described by FIGS. 8 and 9.

This 10^{th} implementation is based on the Paillier ciphertext multiplication method described in document Ref.3. and summarised briefly hereinafter:

It is considered that there is a mask b previously generated at random in Z_{N}.

An initial data item (or message) m is considered. using this data item m and the mask b, a ciphertext CF is defined, with reference to the authors Catalano and Fiore of Ref.3, annotated [m,b]_{CF}, as follows:

$${[ m , b ]}_{CF} = ( m - b ; EncP ( b ) ) = ( {m - b ; [ b ]}_{P} ) = ( c 0 , c 1 )$$

where EncP, also annotated [.]_{P}, denotes the Paillier encryption function.

Let us now consider two ciphertexts CF, namely the pair [m,b]_{CF}=(m-b;EncP(b)), also annotated (c0,c1), and the pair [m′,b′]_{CF}=(m′-b′;EncP(b′)), also annotated (c′0,c′1).

The intermediate variables a1, a2 and a3 are defined by the equations:

a1=EncP(c0×c′0 mod n);a2=c1^{c′0} mod n²;a3=c′1^{c0} mod n².

Using these variables a1, a2 and a3, the product of the two ciphertexts CF is then defined by the triplet (a1a2a3 mod n²; c1; c′1)=(c″0; c″1; c″2).

It is easily verified that c″0 is indeed equal to the ciphertext under Paillier encryption of the product mm′-bb′. The product of the two ciphertexts CF therefore equals:

$$( m - b ; EncP ( b ) ) * ( m ’ - b ’ ; EncP ( b ’ ) ) = ( EncP ( mm ’ - bb ’ ) , EncP ( b ) , EncP ( b ’ ) ) .$$

This operation therefore makes it possible to carry out a form of multiplication of the two initial ciphertexts CF, on the basis of the Paillier additive homomorphic cryptosystem.

However, the result obtained by this multiplication is a triplet: the triplet (c″₀, c″₁, c″₂), and not a ciphertext CF (a pair), like the initial data. The multiplication operation therefore cannot follow each other directly because a multiplication operation expects ciphertexts CF and not triplets as an input.

The computing method according to the present disclosure will make it possible to overcome this problem by delegating the reconversion of the triples into ciphertexts CF to the TEE. This operation is a support function, because it contributes to computing under homomorphic encryption by the server.

FIG. 10 shows the preparation of data supplied as an input for the computing, in a scenario wherein a data item m is supplied as an input by a client CL1, and a data item y is supplied as an input by the server.

During step S1 (S1001), the data item m undergoes two successive masking encryption operations: a first masking Enc_{M}1₁, during which a mask p is applied to the data item x; followed by an additional masking Enc_{M}1₂ (additional encryption) during which a mask a is applied to the data item x+p: this gives [m]_{11,12}=m+μ+a.

During step S2 (S1002), the encrypted data item m+μ+a is sent to the TEE.

In a step S1030, the TEE removes the mask a (the additional encryption) and obtains the data item under first encryption m+μ.

In parallel, the TEE generates a mask b, and computes a Paillier ciphertext [b]_{P} of this mask (step S1031P).

These two latter elements, as well the data item under first encryption x+p are then combined to form a ciphertext CF (m+μ−b;[b]_{P}) in step S31 (S1031).

Moreover, the server supplies an input data item y for the computing. It masks it by adding a mask μ′ and obtains a ciphertext under first encryption Enc11: [y]₁₁=y+μ′ (step S1001ₐ).

In parallel, the TEE generates a mask b′, and computes a Paillier ciphertext [b′]_{P} of this mask (step S1031P also).

These two latter elements, as well the data item under first encryption y+p are then combined to form a ciphertext CF (y+μ′−b′;[b′]_{P}) in step S31 (S1031).

In this example, the two ciphertexts CF (x+p−b;[b]_{P}) and (y+p′−b′;[b′]_{P}) are computed and sent to the server in step S32 (S1032) for carrying out elementary computing operations.

During the implementation of the computing method according to the present disclosure, these operations are carried out as follows.

It is considered that the elementary operations to be carried out by the server are either additions, or multiplications. These two cases are treated differently.

On one hand, in respect of additions, the server can successively carry out any number of addition operations (because the addition operation does not have the drawback described above, so as to supply a triplet and not a ciphertext CF as an output; for more details on this operation, refer to document Ref.3).

Conversely, multiplication operations are carried out as follows, illustrated by FIG. 11.

To carry out a multiplication operation between two data items m and m′, it is assumed that the TEE has two ciphertexts of these data, under first encryption Enc11:

$${{[ m ]}_{11} = m + μ and [ m ’ ]}_{11} = m ’ + μ ’ .$$

These ciphertexts can be for example data supplied by clients such as the data item m+μ of FIG. 10, or data supplied by the server such as the data item y+μ′ of FIG. 10, or data produced by computing in the TEE using data supplied by the server, such as the data item mm′+μ″ which will be described hereinafter.

The TEE supplies two masks b and b′, and the Paillier ciphertexts [b]_{P} and [b′]_{P} of these masks (step S1031P or S1131P).

The TEE then computes the ciphertexts CF of the two ciphertexts to be multiplied (step S1031 or S1131, which represent the same step). These ciphertexts CF are therefore presented in the form of two pairs (m+μ−b;[b]_{P}) et (m′+p′−b′;[b′]_{P}). Here the masks μ and μ′ are known to the server but indecipherable by the TEE. The encryption CF, which constitutes the second encryption, is indecipherable by the server.

The TEE sends the ciphertexts CF to the server (step S1032 or S1132).

The server removes the first encryption Enc1₁ by removing the mask μ, μ′ from each of the ciphertexts in step S33 (S1133).

The server then carries out the multiplication operation between ciphertexts CF described by the algorithm proposed by document Ref.3 (step S1134). Following this operation, the server obtains the triplet ([mm′-bb′]_{P};[b]_{P};[b′]_{P}).

The server then encrypts the triplet by adding a mask μ″ to the 1^{st} term of triplet thanks to the additive homomorphism property of the Paillier encryption schema (step S1134a). It then sends the result obtained (mm′-bb′+μ″;[b]_{P};[b′]_{P}) to the TEE.

The TEE removes the encryption from the three ciphertexts under Paillier encryption (step S1136). It obtains (mm′-bb′+μ″,b,b′) and can thus compute:

$$mm ’ - bb ’ + μ ” + b * b ’ = mm ’ + μ ”$$

The multiplication product mm′ thus remains under first encryption, such that the TEE does not know the value of this product.

As in the general case of the 9^{th} implementation, the processing performed by the TEE is not the same if all the elementary operations have been carried out and the current loop is the last loop of index j=N, or not, in which case at least one computing loop (j<N) remains.

In the first case, i.e. if j=N, the result obtained following step S1136 is also the computing result, under first encryption:

$$mm ’ + μ ” = F ( x ) + μ ” = {[ F ( x ) ]}_{11} .$$

In this case, this encrypted result undergoes the operations of steps S1137 and S4 as in the general case of the 9^{th} implementation (FIG. 9): In step S1137, the TEE applies an additional encryption Enc1₂ to it and sends the result obtained to the client CL1.

In step S4, the client CL1 successively removes the additional encryption (applies the function Dec_{M}1₂), then removes the first encryption (applies the function Dec_{M}1₁), which makes it possible to obtain the result sought F(x).

Conversely, if there are one or more elementary operations remaining to be performed (j<N), the TEE generates a new mask b″, and computes a Paillier ciphertext [b″]_{P} of this mask (step S1131P). The mask b″ and its ciphertext [b″]_{P} are then combined with the ciphertext mm′+μ″ so as to obtain a ciphertext CF (step S31). The pair (mm″+μ″−b″; [b″ ]_{P}) is then re-sent to the server: the computing operations can then be continued for the next iteration on the basis of this pair as an input and another value with which it is to be multiplied, and so on.

This 10^{th} implementation has the benefit, with respect to the 9^{th} implementation, of not needing the signature operations provided in the latter case.

### REFERENCES

Ref.1—L. Coppolino, S. D'Antonio, V. Formicola, G. Mazzeo and L. Romano, “VISE: Combining Intel SGX and Homomorphic Encryption for Cloud Industrial Control Systems” in IEEE Transactions on Computers, vol. 70, no. 5, pp. 711-724, 1 May 2021, doi: 10.1109/TC.2020.2995638.
Ref.2—Wang, W., Jiang, Y., Shen, Q., Huang, W., Chen, H., Wang, S., . . . & Lin, D. (2019). Toward scalable fully homomorphic encryption through light trusted computing assistance. arXiv preprint arXiv:1905.07766.
Ref.3—D. Catalano, D. Fiore, “Boosting Linearly-Homomorphic Encryption to Evaluate Degree-2 Functions on Encrypted Data”, Cryptology ePrint Archive, Paper 2014/813.
Ref.4—D. Natarajan, A. Loveless, W. Dai, R. Dreslinski, “Chex-Mix: Combining homomorphic Encryption with Trusted Execution Environments for Two-party Oblivious Inference in the Cloud’, IACR, International Association for Cryptographic Research, vol. 20220908:153418.
Ref.5—D. Fiore, R. Gennaro, V. Pastro, “Efficiently Verifiable Computation on Encrypted Data”, Cryptology ePrint Archive, Paper 2014/202.

1. A method for processing data in a system comprising two computers to obtain a result using at least one input data item to be supplied by at least one emitting client, the result being obtained by applying a combination of elementary operations to at least one input data item; wherein
one of the computers is a server, and the other is a trusted execution environment, TEE;
a first encryption [Enc1,Dec1] and a second encryption [Enc2,Dec2] are defined, one being indecipherable by the server, and the other being indecipherable by the TEE;
the method includes the following steps:
S1) at least one emitting client supplies a first input data item and applies the first encryption to it;
S2) said at least one emitting client sends the input data item under the first encryption to one of the computers;
S3) during a data processing operation, the two computers apply the combination of elementary operations to said encrypted data item received in step S2 so as to obtain a ciphertext of the result, and send this result to at least one receiving client, step S3 including the following elementary steps:
S31) the first computer encrypts the processed data item under second encryption;
S32) the first computer sends the second computers the processed data item obtained, encrypted under first and second encryption; and
S33) the second computer removes the first encryption from the processed data item received;
S4) said at least one receiving client deciphers the ciphertext of the result and obtains the result;
during the data processing performed in step S3, the server only processes processed data under at least the encryption indecipherable by the server, and the TEE only processes processed data under at least the encryption indecipherable by the TEE, which may be in particular be masking encryption; and
the first and the second encryption verify the property, for any processed data item x:
Dec2(Dec1(Enc2(Enc1(x))))=Dec2(Enc2(x)).

2. The data processing method according to claim 1, wherein said encryption indecipherable by the server is or comprises a homomorphic, in particular fully homomorphic, encryption.

3. The data process method according to claim 2, wherein in step S3, the TEE applies to the processed data item or to the processed data only one or more support functions;
a support function being a function other than said elementary operations and which:
contributes to the execution of homomorphic computing operations by the server or to the verification thereof;
serves to encrypt or decipher data to be processed received from the client, processed data (by the computers), or results sent to the client; and/or
serves to prepare (verification) data serving to verify data to be processed received from the client, processed data, and/or results sent to the client.

4. The data processing method according to claim 1, including the following steps:
S0235) the second computer applies the first encryption to the deciphered data item during step S33, and sends the data item obtained to the first computer; and
S0236) the first computer removes the second encryption from the processed data item received following step S0235.

5. The data processing method according to claim 4, wherein step S0235 is performed immediately following step S33, such that during step S0235, the second computer applies the first encryption to the processed data item obtained at the output of step S33.

6. The data processing method according to claim 1, wherein during step S3, the processed data item is encrypted under an encryption other than the first encryption or is encrypted with the first encryption but with another encryption key; and the encrypted result returned following step S3 is encrypted with a different encryption from the first encryption or is encrypted with the first encryption but with another encryption key.

7. The data processing method according to claim 1, wherein a receiving client receiving the encrypted result following step S3, is identical to or different from the or each of said at least one emitting client supplying the data item in step S1.

8. The data processing method according to claim 1, furthermore including a step S0411 preceding step S2 and during which the first client applies an additional encryption, particularly symmetric, to the data item; and after the data item has been sent to the first computer in step S2, the first computer removes the additional encryption.

9. The data processing method according to claim 1, wherein
during an operation S0533, the TEE removes the first encryption, referred to as initial first encryption, which can in particular be a masking encryption, from the processed data item; and
during an operation S0535, the TEE applies to the processed data item a homomorphic encryption, as final first encryption;
during an operation S0535a, following step S0535, the processed data item under final first encryption and under second encryption is sent to the server;
when all of the elementary operations have been performed, the ciphertext of the result is sent to the client under final first encryption; and in step S4, the client removes the final first encryption.

10. The data processing method according to claim 1, wherein
the first encryption applied in step S1 is homomorphic encryption referred to as first homomorphic encryption;
during a step S0633, the TEE removes the first homomorphic encryption from the processed data item;
during a step S0635 performed after step S0633, the TEE applies to the data item a second homomorphic encryption other than the first homomorphic encryption; and
in step S4, the client removes the second homomorphic encryption from the encrypted result.

11. The data processing method according to claim 1, wherein
the combination of elementary operations includes N elementary operations of order j, j=1 . . . N;
step S3 includes the execution of a plurality of computing loops, iteratively;
in each loop of index j, j=1 . . . N, steps S1, S31, S32 and S33, a step S0730, a step S0735 and a step S0736 are carried out as follows:
during step S1, the client supplies an input data item of index j, and sends said input data item of index j to the first computer, which is the server, as an input data item for step S0730;
during step S0730, the server applies the elementary operation of index j to the data item supplied as an input;
the server carries out step S31 of applying the second encryption to the processed data item and step S32 of sending the encrypted processed data item to the TEE;
the TEE carries out step S33 of removing the first encryption from the processed data item, then in step S0735 applies once again the first encryption to the data item, then resends the thus re-encrypted data item to the server;
on receipt of said thus re-encrypted data item, the server during a step S0736a removes the second encryption therefrom; the data item thus modified is then supplied as an input data item of operation S0730 of the following computing loop where applicable.

12. The data processing method according to claim 11, wherein
a verifiable computing protocol is defined, which makes it possible to verify the result by carrying out an elementary verification for each of said elementary operations;
the first computer is the server, and the second computer is the TEE;
a tag computing function is defined in the context of the verifiable computing protocol, this function being commutative with the elementary operations gⱼ;
in step S1, the client furthermore sends the server a tag of the ciphertext under first encryption of the data item;
the second encryption is a mask encryption;
in each loop of index j, j=1 . . . N:
in a step S0701a, the client supplies the server with a mask and a mask tag of the mask;
during a step S0730, the server applies the elementary operation of index j to the processed data tag supplied as an input;
during a step S0731, the server encrypts the processed data item under second encryption;
during a step S0732, the server sends the TEE the processed data item obtained, encrypted under first and second encryption;
during a step S0730a, the server applies the elementary operation of index j to the data tag supplied as an input;
during a step S0731a, the server computes the tag of the ciphertext under double encryption using the tag obtained in step S0730a and the tag of the mask mⱼ, and sends this tag to the TEE;
during a step S0732a, according to the encrypted data item received in step S0732, and the encrypted data tag received in step S0731a, the TEE verifies the elementary operation carried out in step S0730 by performing the elementary verification corresponding to this operation;
if the result is positive and the loop index j verifies j<N, in step S0733:
the TEE removes the first encryption (Dec_{HE}1) from the encrypted data item received in step S0732 performed during the loop, then
during a step S0735, applies the first encryption to the data item under second encryption and sends the encrypted data item obtained to the server;
during a step S0736, the server removes the second encryption from the data item received following step S0735, and supplies the thus deciphered data item as an input data item for operation S0730 of the following computing loop;
during a step S0735a, the TEE computes a tag of the encrypted data item computed in step S0735 and sends this tag to the server; then
during a step S0736a, the server computes the tag of the unmasked ciphertext using the tag received following step S0735a and the tag of the mask, and supplies the tag of the unmasked ciphertext as an input data item for operation S0730a of the following computing loop.

13. The data processing method according to claim 11, wherein
the first computer is the TEE;
during at least one of the computing loops, referred to as loop J, of index j=J, the method is executed as follows:
in step S32 of the loop J, in addition to the encrypted data item under first and second encryption, the first computer sends the second computer a signature thereof, as well as another encrypted data item under first and second encryption accompanied by a signature thereof;
in step S33 of the loop J, the server removes the first encryption from the encryption data under double encryption and from said other data item received in step S32;
in a step S0934 of the loop J, the server applies the elementary operation of index J to the two deciphered data items obtained in step S33;
in a step S0934a of the loop J, the server applies the first encryption (Enc_{M}1₁) to the data item obtained;
the server furthermore computes a computing proof proving that the encrypted data item obtained following step S0934a is indeed the result of the application of the elementary operation of index J to the two data items used as an input for step S0934, and sends the encrypted data item obtained in step S0934a as well as the proof to the TEE;
during a step S0934b, the TEE verifies at least if the proof corresponds to the computing result; and,
if the verification result is positive, in a step S0936, the first computer removes the second encryption from the data item, and supplies the data item obtained as an input for a step S31 of the following index loop where applicable; if the verification result is negative, the TEE interrupts the processing.

14. The data processing method according to claim 11, wherein
the first computer is the TEE;
the second encryption being a homomorphic encryption ensuring security against CCA attacks, for example Paillier encryption;
during at least one of the computing loops, referred to as loop J, of index j=J, the method is executed as follows:
in step S32 of the loop J, in addition to the encrypted data item under first and second encryption, the TEE sends the server another encrypted data item under first and second encryption;
in step S33 of the loop J, the server removes the first encryption from the encryption data item under double encryption and from said other data item received in step S32;
in a step S1134 of the loop J, the server applies the elementary operation of index J to the two deciphered data items obtained in step S33;
in a step S1134a of the loop J, the server applies the first encryption to the data item obtained by applying the elementary operation of index J in step S1134;
the server sends the encrypted data item obtained in step S1134a to the TEE; and,
in a step S1136, the TEE removes the second encryption from the data item, and supplies the data item obtained as an input for a step S31 of the following index loop where applicable.
